(19) United States
(12) Patent Application Publication
(10) Pub. No.: US 2008/0033677 A1
(43) Pub. Date: Feb. 7, 2008

(54) Methods And System For Compensating For Spatial Cross-Talk

(75) Inventors: Austin B. Tomaney, San Francisco, CA (US); David P. Holden, Burlingame, CA (US); Mark R. Pratt, San Mateo, CA (US); H. Pin Kao, Fremont, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 11/761,236

(22) Filed: Jun. 11, 2007

Related U.S. Application Data
(60) Provisional application No. 60/805,956, filed on Jun. 27, 2006.

(51) Int. Cl. G06F 19/00

(52) U.S. Cl. 702/85; 359/893

(57) ABSTRACT

An embodiment generally relates to a method of processing signals. The method includes providing for a plurality of filters, where each filter is configured to process an associated dye. The method also includes determining a residual error for at least one filter during dye amplification and modifying the at least one filter based on the residual error. The method further includes filtering subsequent signals associated with the modified at least one filter.

### FIELD

This invention relates generally to processing data. More particularly, embodiments relate to methods and apparatus for compensating for spatial cross-talk.

### DESCRIPTION OF THE RELATED ART

A signal that is physically isolated, for example, light coming from a well in a plate, is observed to be spread out when imaged in an optical imaging system. The blurring is due to a point spread function of the sensor of the optical imaging system. This introduces optical cross-talk in neighboring feature signals and therefore systematic errors in the quantification of the features. In particular, this can mean that the integrated flux from a faint feature situated in a neighborhood of surrounding bright signals can be biased upwards due to the contribution of signals from its neighbors introduced by the optics in the imaging system.

### SUMMARY

An embodiment generally relates to a method of processing signals. The method includes providing for a plurality of filters, where each filter is configured to process an associated dye. The method also includes determining a residual error for at least one filter during dye amplification and modifying the at least one filter based on the residual error. The method further includes filtering subsequent signals associated with the modified at least one filter.

Another embodiment pertains generally to an apparatus for calibrating for spatial cross-talk correction in an imaging system. The apparatus includes a plate comprising an array of pinholes. Each pinhole substantially smaller than the resolution of the imaging system, where the plate is configured to be illuminated and imaged by the imaging system to correct for spatial cross-talk.

Yet another embodiment relates generally to a system. The system includes a calibration plate, a light source configured to illuminate the calibration plate, and a processor configured to receive digitize image of an illuminated calibration plate. The processor is configured to image the illuminated calibration plate to form an initial image, smoothing the initial image, and subtract the initial image from the smoothed initial image to form a calibrated image.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates a block diagram of an exemplary system where an embodiment can be practiced;

FIG. 2 illustrates a more detailed block diagram of the light separator shown in FIG. 1;

FIG. 3 illustrates an exemplary calibration plate in accordance with another embodiment;

FIG. 4 illustrates a flow diagram executed by the system shown in FIG. 1;

FIG. 5 illustrates a before and after images calibration images;

FIG. 6 illustrates another flow diagram executed by the system shown in FIG. 1;

FIG. 7 depicts output images from the system shown in FIG. 1;

FIG. 8 illustrates yet another flow diagram executed by the system shown in FIG. 1; and

FIG. 9 illustrates another output image from the system shown in FIG. 1.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of systems that generate signals, and that any such variations do not depart from the true spirit and scope of the present invention. Moreover, in the following detailed description, references are made to the accompanying figures, which illustrate specific embodiments. Electrical, mechanical, logical and structural changes can be made to the embodiments without departing from the spirit and scope of the present invention. The following detailed description is, therefore, not to be taken in a limiting sense and the scope of the present invention is defined by the appended claims and their equivalents.

Embodiments generally relate to a method of compensating for spatial cross-talk on an optical imaging system. More particularly, a high signal/noise image of a calibration plate can be used to calibrate the point spread function (“PSF”) of a sensor of the imaging system. The calibration plate can be configured to be at least the same size and in the same position as a user's test plate. The calibration plate can comprise an array of pinholes that is illuminated from the bottom of the calibration plate. The size of the pinholes can be substantially smaller than the resolution of the imaging system, and thus the images of the pinholes are unresolved, which then measure directly the PSF of the optical sensor, e.g., a camera. The distance between the pinholes can be at least three times that of the separation of features that are being measured on the imaging system. The images of the pinholes can be taken for all passbands that are to be corrected for spatial cross-talk. Moreover, the reciprocal of the signal-to-noise (“S/N”) of a pinhole should substantially exceed the cross-talk coefficients being measured. Accordingly, many unsaturated images can be co-added together to increase the S/N of the pinholes.

The image of the calibration plate is taken with an intensity range that is set low enough to highlight the background variation and the pinhole signals. The image of the calibration plate can then be smoothed using a boxcar 2-dimensional function or other similar smoothing function. The smoothed image can be subtracted from the initial image to remove the large scale features of any background to generate a calibrated image, thereby setting the background to zero.

In another embodiment, the calibrated image can be used to generate a PSF for a region of interest. More specifically, the PSF typically varies significantly over the field of view (“FOV”) of the sensor of the optical imaging system. One approach to correct for the varying PSF is to use image deconvolution that attempts to improve the clarity and/or quality of the image. Accordingly, in one embodiment, the calibrated image can be partitioned into a number of regions-of-interests (“ROIs”), where the PSF remains substantially constant over each ROI. Accordingly, small subimages of the pinholes located within a selected ROI can be created. Each feature in the subimage of the selected ROI is normalized to an integrated intensity of unity. Subsequently, a determination of an intensity weighted centroid is made for each pinhole in the subimage and then shifted to have its centroid in the middle of the subimage. The processed subimages are averaged to provide a high final S/N PSF subimage. In some embodiments, a median aggregation can be used to minimize any systemic artifacts in the individual pinholes. If the region cannot maintain a constant PSF, then smaller regions can be chosen to ensure a constant PSF.

Another embodiment generally relates to a method for spatial cross-talk correction of extracted intensities. More particularly, one approach for spatial cross-talk correction can extract feature intensities directly from the image (after background correction) and apply spatial cross-talk correction on these intensities. Accordingly, the calibrated image is initially convolved with an intrinsic feature profile such as an idealized two dimensional square (or circular) top hat function. In other embodiments, the intrinsic profile can be a kernel that is derived from real well profiles (ideally after accurate image deconvolution where the PSF component of the measured profile is removed). The convolved image is then quantified with the same algorithm that a user uses to quantify data. The quantification is performed at the convolved pinhole positions as well as all relative neighboring feature locations. In some embodiments, the neighboring positions can be in a checkerboard arrangement. In other embodiments, additional next nearest neighborhood coefficients can be measured if the spacing and S/N of the pinholes permit. A crosstalk coefficient can then be derived at each pinhole location in each neighbor direction as the ratio of the flux in the neighbor direction divided by the convolved pinhole flux. For each directional coefficient, the S/N of its estimate for a given location can be increased by aggregating its neighbor values at the appropriate scale.

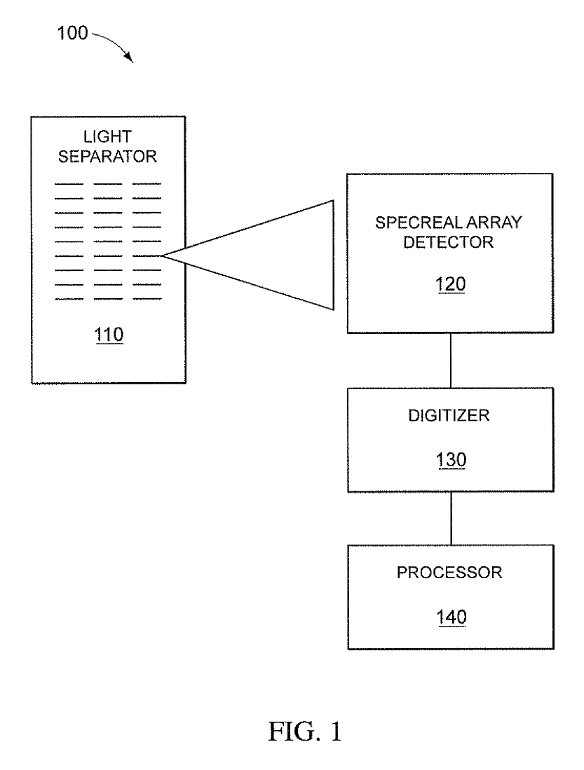

FIG. 1 is an exemplary system 100 consistent with the present invention. It should be readily apparent to those of ordinary skill in the art that the system 100 depicted in FIG. 1 represents a generalized schematic illustration and that other components can be added or existing components can be removed or modified. Moreover, the system 100 can be implemented using software components, hardware components, or combinations thereof.

The system 100 includes a light separator 110, a spectral array detector 120, a digitizer 130, and a processor 140. The light separator 110 spatially separates multiple spectrally-distinguishable species. The light separator 110 may include a spectrograph, a diffraction grating, a prism, a beam splitter in combination with optical filters, or similar elements.

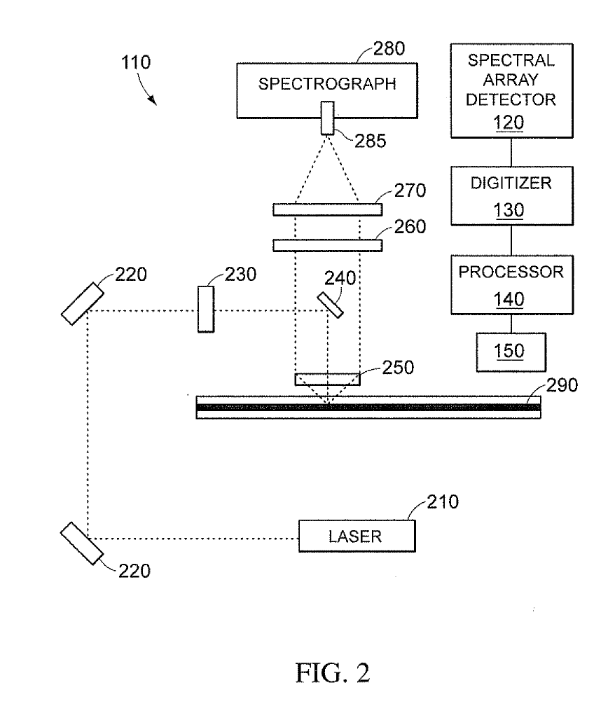

FIG. 2 is a detailed diagram of the light separator 110 in an implementation consistent with the present invention. The light separator 110 includes a laser 210, a pair of mirrors 220, lenses 230, mirror 240, lens 250, filter 260, lens 270, and spectrograph 280. The laser 210 is an excitation light source, such as an argon ion laser, that may emit a polarized light beam. The mirrors 220 may be adjustably mounted to direct the laser light beam to the desired location. The lenses 230 may include telescope lenses that reduce the diameter of the light beam reflected by the mirrors 220 and present the reduced light beam to the mirror 240. The mirror 240 may include a bending mirror that directs the light to an electrophoresis medium 290, such as an aqueous gel.

The lens 250 may include an aspheric collection lens that collects the light emitted from the laser-excited medium 290 and collimates the light in the direction of the filter 260, bypassing mirror 240. The filter 260 may include a laser rejection filter that reduces the level of scattered laser light transmitted to the lens 270. The lens 270 may include a plano-convex lens that focuses the filtered light to the spectrograph 280. The spectrograph 280 may include a slit 285 that receives the light from the lens 270 and a blaze grating (not shown) that separates the light into its spectral components. The spectrograph 280 outputs the light to the spectral array detector 120.

Returning to FIG. 1, the spectral array detector 120 includes an optical detector that can simultaneously detect and identify an intensity of multiple wavelengths of light. The spectral array detector 120 may include an array of detector elements sensitive to light radiation, such as a diode array, a charged coupled device (CCD), a charge induction device (CID), an array of photomultiplier tubes, etc. The output of the spectral array detector 120 is light intensity as a function of array location, such that the array location can be directly related to the wavelength of the light impinging on that location.

The digitizer 130 receives the output from the spectral array detector 120, digitizes it, and presents it to the processor 140. The digitizer 130 may include an analog-to-digital converter or a similar device. The processor 140 operates upon the digitized output of the spectral array detector 120 to perform spectral calibration and compensation. The processor 140 may include any conventional processor, microprocessor, digital signal processor, or computer capable of executing instructions. The processor 140 may also include memory devices, such as a RAM or another dynamic storage device, a ROM or another type of static storage device, and/or some type of magnetic or optical recording medium and its corresponding drive; input devices, such as a keyboard and a mouse; output devices, such as a monitor and a printer; and communication device(s) to permit communication with other devices and systems over any communication medium.

As will be described in detail below, the processor 140, consistent with the present invention, operates upon data resulting from an analytical separation of spectrally-distinguishable molecular species to perform spectral calibration and spatial cross-talk correction of high density feature signals. The processor 140 performs the spectral calibration and cross-talk correction by executing sequences of instructions contained in a memory. Such instructions may be read into the memory from another computer-readable medium or from another device over a communications medium. Execution of the sequences of instructions contained in the memory causes the processor 140 to perform the methods that will be described hereafter. Alternatively, hardwired circuitry may be used in place of or in combination with software instructions to implement the present invention. Thus, the present invention is not limited to any specific combination of hardware circuitry and software.

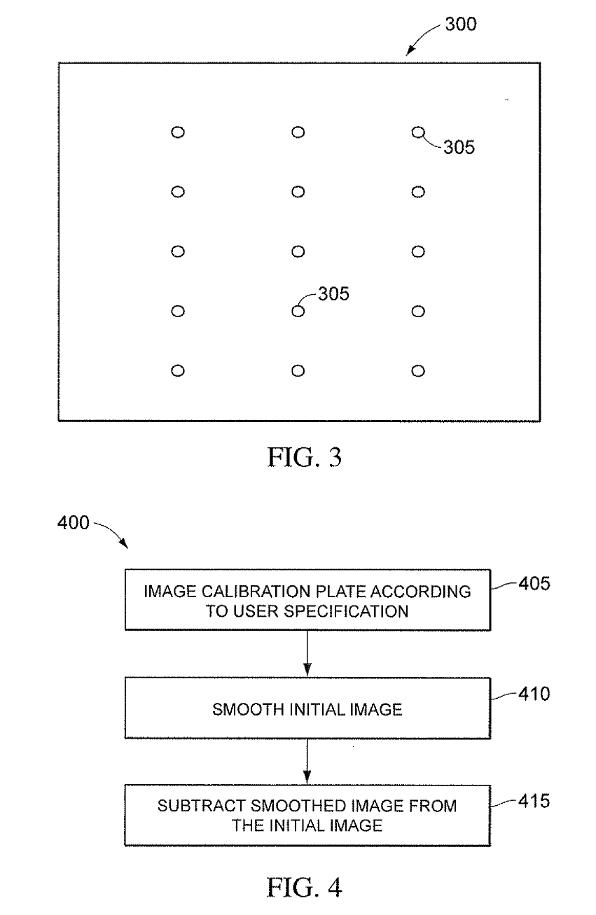

FIG. 3 illustrates a top view of the calibration plate 300 used in the system 100. As shown in FIG. 3, the calibration plate 300 can be implemented using a material such as aluminum deposited on glass. Pinholes are laser ablated into the aluminum coating. The calibration plate 300 can also comprise an array of pinholes 305. According to various embodiments each pinhole 305 can provide a channel for light to traverse through the calibration plate 300. The diameter of each pinhole 305 can be configured to be significantly smaller than the resolution of the system 100. Accordingly, the images of the pinholes are unresolved and thus provide a direct measure of the point spread function (“PSF”) of the spectral array detector 120.

According to various embodiments the pinholes 305 of the calibration plate 300 can be spaced at least three times the separation of the features that are being measured by the system 100. Accordingly, spatial cross-talk can be measured at the neighbor location while at the same time leaving enough of a region free of signals contaminating the background so that an accurate estimate of the background around each pinhole can be made.

Returning to the processor 140, in certain embodiments, can include a calibration module configured to calibrate the spectral array detector with the calibration plate 300 as well as provide information to correct and/or enhance the imaged data as described above and in greater detail below. Accordingly, the processor 140 can include a calibration data module 150 for storing the calibration and/or image correction data. The calibration data module 150 can be implemented in a separate memory or allocated in the memory space of processor 140.

FIG. 4 illustrates a flow diagram 400 implemented on the imaging system 100 in accordance with another embodiment. It should be readily apparent to those of ordinary skill in the art that the flow diagram 400 depicted in FIG. 4 represents a generalized schematic illustration and that other steps can be added or existing steps can be removed or modified.

As shown in FIG. 4, a user can image the calibration plate 300 according to the user's typical test specification, in step 305. More particularly, for the most accurate results, the calibration plate 300 can be positioned in the same location in the vertical and horizontal axes as a user's test plate. When the calibration plate is in position, the spectral array detector 120 can image the calibration plate 300 at the appropriate wavelength or band of wavelengths. The spectral array detector 120 can store this initial image in an attached storage (not shown).

In step 310, the processor 140 can be configured to smooth the initial image. More specifically, the processor 140 can apply a boxcar two dimensional median function to the initial image to form a smoothed image. In other embodiments, other smoothing functions can be applied to the initial image.

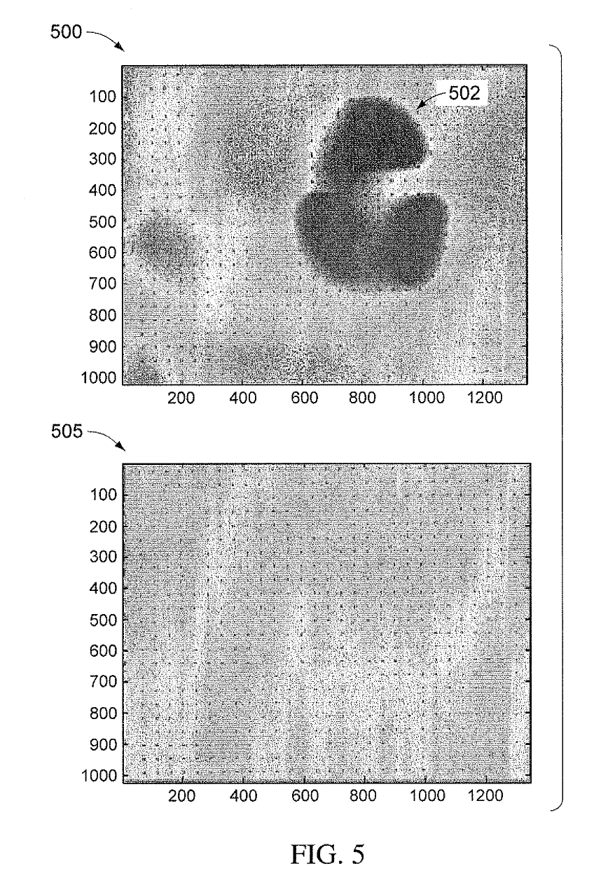

In step 315, the processor 140 can subtract the smoothed image from the initial image to form a calibration image. The subtraction of the images provides for a removal of large scale background features, which can be seen in FIG. 5. Thus, the calibration image can set the image background to zero.

FIG. 5 illustrates a comparison of an initial image 500 with a calibration image 505. As shown in FIG. 5, the initial image 500 is an image of pinhole image of an exemplary calibration plate 300. A large scale feature 502 can be seen in the area bounded on the horizontal axis (600-1200) and the vertical axis (700-100). For this embodiment, the intensity range is set low to highlight the background variation in addition to the signals emanating from the pinholes. The calibration image 505 is the result of a smoothing of the initial image 500 and a subtraction of the calibration image 505 from the initial image 500. The large scale feature 502 has been removed, thus setting the background to zero.

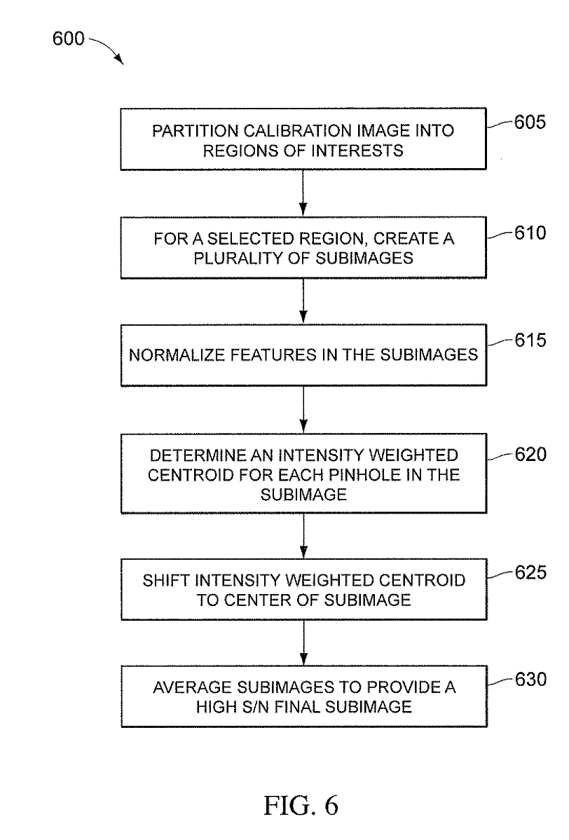

FIG. 6 illustrates a flow diagram 600 implemented on the system 100 in accordance with another embodiment. It should be readily apparent to those of ordinary skill in the art that the flow diagram 600 depicted in FIG. 6 represents a generalized schematic illustration and that other steps can be added or existing steps can be removed or modified.

As shown in FIG. 6, the processor 140 of the imaging system 100 can be configured to retrieve a calibration image from attached storage and partition the calibration image into regions of interests, in step 605. The region of interests can be set to a size where the PSF over the selected region of interest remains substantially constant. Otherwise, if the PSF cannot remain constant, a smaller region of interest should be selected.

In step 610, the processor 140 can create multiple subimages from each region of interest. In step 615, the processor 140 can then normalize any feature located in each subimage to an integrated intensity of unity.

In step 620, the processor 140 can determine an intensity weighted centroid for each pinhole in each of the subimages. Subsequently, the processor 140 can shift the calculated intensity weighted centroid to the center of the subimage, in step 625.

In step 630, the processor 140 can then average the centroids in the subimages to provide a high signal-to-noise (S/N) final subimage.

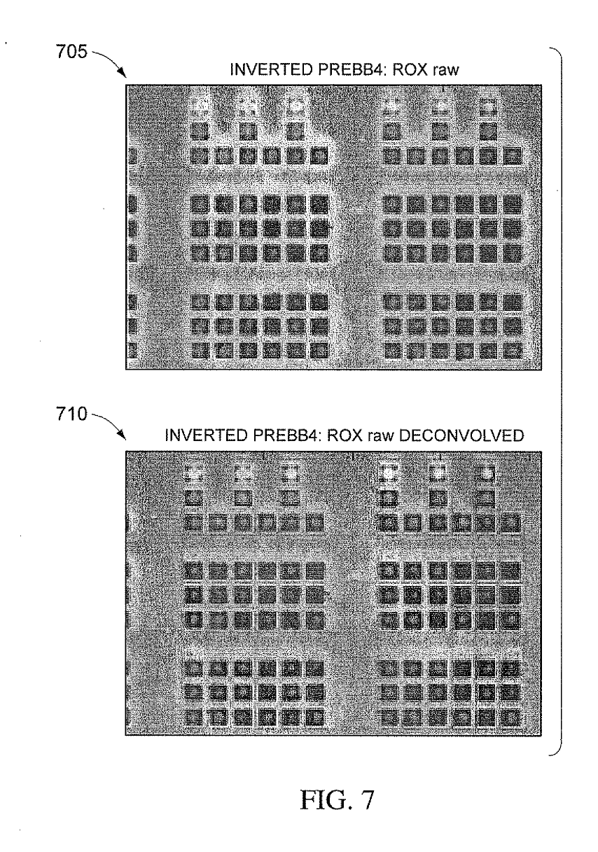

FIG. 7 illustrates a comparison of before 705 and after 710 spatial deconvolution subimages using PSFs derived from the flow diagram 600. It is noteworthy to note that substantial reduction of the bleeding of each well's signal into its neighbor's. For this image, a Lucy Richardson (L R) deconvolution algorithm was used on the image where the raw image is minimally corrected for the charged coupled device (CCD) bias and scaled from counts to photons to preserve photon statistics needed for the LR algorithm.

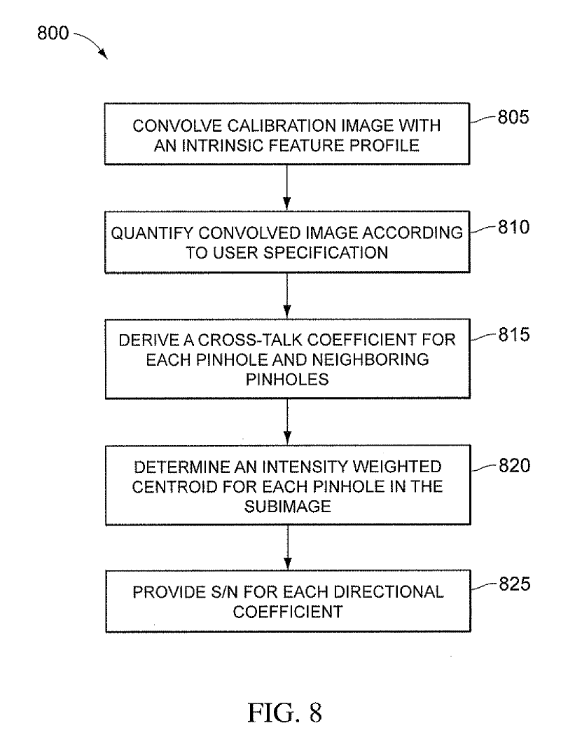

FIG. 8 illustrates a flow diagram 800 implemented on the system 100 in accordance with another embodiment. It should be readily apparent to those of ordinary skill in the art that the flow diagram 800 depicted in FIG. 8 represents a generalized schematic illustration and that other steps can be added or existing steps can be removed or modified.

As shown in FIG. 8, the processor 140 of the system 100 can be configured to retrieve a calibration image from attached storage and convolve the calibration image with an intrinsic feature profile, in step 805. An example of an intrinsic feature profile can be an idealized two-dimensional square (or circular) top hat function. It should be readily obvious to one of ordinary skill that other functions can be substituted and not depart from the spirit and/or scope of the claims.

In step 810, the processor 140 can quantify the convolved image according to a user specification. In other words, the processor 140 can use the same algorithm that quantifies the user data. The quantification is performed at the convolved pinhole positions as well as all relative neighboring feature positions. In some embodiments, the relative neighboring feature positions can be in a checkerboard arrangement. In other embodiments, the next-nearest neighbor coefficients can be assumed to be negligible but in other embodiments, can be measured if the spacing and S/N of the pinholes permit it.

In step 815, the processor 140 can determine a cross-talk coefficient at each pinhole location in each neighbor direction as the ratio of the flux in the neighbor direction divided by the convolved pinhole flux. In other embodiments, the cross-talk coefficient can be determined for more than the immediate neighbors.

In step 820, the processor 140, for each directional cross-talk coefficient, can then provide an estimate of the S/N for a selected pinhole that can be increased by aggregating its neighbor values at the appropriate scale.

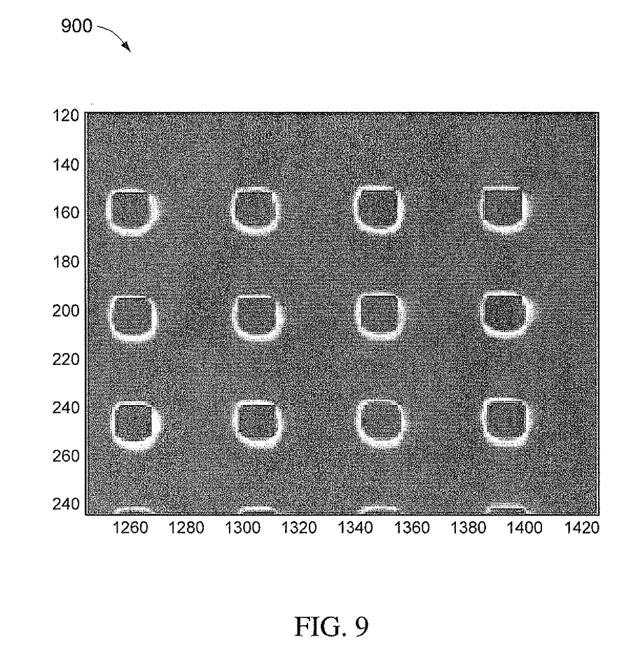

FIG. 9 illustrates an image of convolution of a processed pinhole image with a well profile to simulate well images in accordance with flow diagram 800.

Certain embodiments can be performed as a computer program. The computer program can exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. An apparatus for calibrating for spatial cross-talk correction in an imaging system, the apparatus comprising:
a plate comprising:
an array of pinholes, each pinhole substantially smaller than the resolution of the imaging system, wherein the plate is configured to be illuminated and imaged by the imaging system to correct for spatial cross-talk.

2. The apparatus of claim 1, wherein each pinhole of the array of pinholes is spaced at least three times the separation of features being measured on the imaging system.

3. A method of using the apparatus of claim 1, the method comprising:
imaging the apparatus illuminated to form an initial image;
smoothing the initial image; and
subtracting the initial image from the smoothed initial image to form a calibrated image.

4. The method of claim 3, the method further comprising:
partitioning the calibrated image into a plurality of regions, each region comprising at least one pinhole;
creating at least one subimage from a selected region of the plurality of regions; and normalizing any features located in the at least one subimage.

5. The method of claim 4, further comprising:
determining an intensity weighted centroid associated for each pinhole located in the at least one subimage; and
shifting the intensity weighted centroid to a middle of the subimage.

6. The method of claim 5, further comprising averaging the at least one subimage to provide a final signal-to-noise point spread function (“PSF”) image.

7. The method of claim 5, further comprising using median aggregation on the at least one subimage to provide a signal-to-noise PSF image.

8. The method of claim 3, the method further comprising:
convolving the calibrated image with a feature profile to form a convolved image; and quantifying the convolved image using a user's algorithm at a selected pinhole and neighboring pinholes to the selected pinhole.

9. The method of claim 8, the method further comprising determining a cross-talk coefficient for the selected pinhole in each neighbor direction divided by a convolved pinhole flux.

10. The method of claim 9, further comprising estimating a signal-to-noise ratio for the selected pinhole by aggregating the values associated with the neighboring pinholes for each direction.

11. An apparatus comprising of means for performing the method of claim 3.

12. A computer-readable medium comprising computer-executable instructions for performing the method of claim 3.

13. A system comprising of:
a calibration plate;
a light source configured to illuminate the calibration plate; and
a processor configured to receive digitize image of an illuminated calibration plate, wherein the processor is configured to image the illuminated calibration plate to form an initial image, smoothing the initial image, and subtract the initial image from the smoothed initial image to form a calibrated image.

14. The system of claim 13, wherein the processor is further configured to partition the calibrated image into a plurality of regions, each region comprising at least one pinhole and create at least one subimage from a selected region of the plurality of regions.

15. The system of claim 14, wherein the processor is further configured to normalize any features located in the at least one subimage.

16. The system of claim 15, wherein the processor is further configured to determine an intensity weighted centroid associated for each pinhole located in the at least one subimage and shift the intensity weighted centroid to a middle of the subimage.

17. The system of claim 14, wherein the processor is further configured to average the at least one subimage to provide a final signal-to-noise point spread function (“PSF”) image.

18. The system of claim 17, wherein the processor is further configured to use median aggregation on the at least one subimage to provide a signal-to-noise PSF image.

19. The system of claim 18, wherein the processor is further configured to convolve the calibrated image with a feature profile to form a convolved image and quantify the convolved image using a user's algorithm at a selected pinhole and neighboring pinholes to the selected pinhole.

20. The system of claim 19, wherein the processor is further configured to determine a cross-talk coefficient for the selected pinhole in each neighbor direction divided by a convolved pinhole flux.
